(19) United States
(12) Patent Application Publication
(10) Pub. No.: US 2014/0348499 A1
(43) Pub. Date: Nov. 27, 2014

(54) INFRARED CONTROL DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: JUN LIU, Shenzhen (CN); BING ZHOU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 13/910,137

(22) Filed: Jun. 5, 2013

(30) Foreign Application Priority Data
May 21, 2013 (CN) 2013101897880

(51) Int. Cl. H04B 10/07; G08C 23/04

(52) U.S. Cl. CPC H04B 10/07; G08C 23/04
USPC 398/9

(57) ABSTRACT

An infrared device configured to remotely control a remote controlled device includes an infrared emitter and a processor. The processor includes a pin connected to the infrared emitter, a generating unit, and a control unit. The generating unit is configured to automatically generate different infrared signals each corresponding to a remote signal generated by a remote control of the remote controlled device. The control unit is configured to alternatively set a voltage at the pin to be logic high and logic level to output the different infrared signals to the infrared emitter.

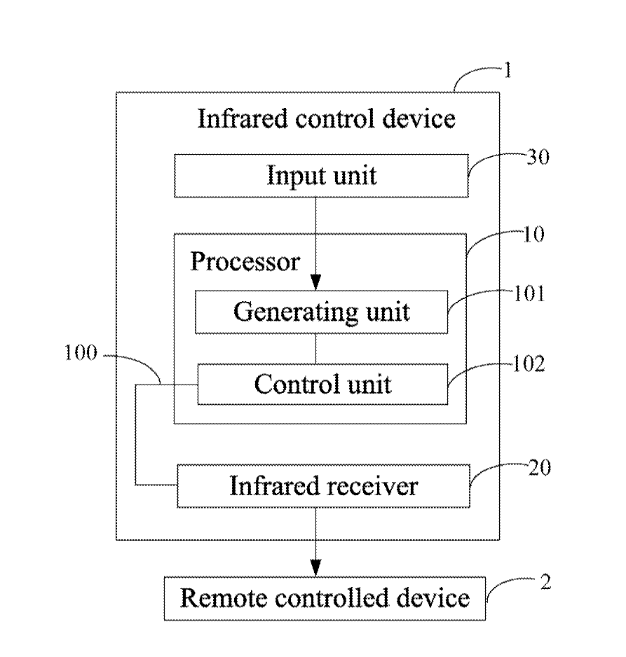

### BACKGROUND

1. Technical Field

The present disclosure relates to electronic devices, and more particularly, to an infrared control device.

2. Description of Related Art

Many electronic devices, such as set top boxes and television sets, can be controlled by infrared (IR) signals from a remote control. Whether or not one such electronic device can normally receive infrared signals needs to be tested during manufacturing. In a typical testing process, buttons of the remote controller are pressed one-by-one, and then whether or not the electronic device executes a right function is checked. However, this typical testing process may be time consuming.

Therefore, there is a need to provide a means to overcome the above-described shortcomings.

### BRIEF DESCRIPTION OF THE DRAWINGS

Many aspects of the present disclosure should be better understood with reference to the following drawing. The emphasis is placed upon clearly illustrating the principles of the present disclosure.

The drawing is a block diagram of an infrared control device, in accordance with an exemplary embodiment.

### DETAILED DESCRIPTION

The drawing is a block diagram of an infrared control device 1 according to an exemplary embodiment. The infrared control device 1 automatically transmits different infrared signals to a remote controlled device 2 to be tested, and then whether or not the remote controlled device 2 can execute a right function when receiving the infrared signals is checked.

The infrared control device 1 includes a processor 10 and an infrared receiver 20. The processor 10 includes a pin 100 connected to the infrared receiver 20, a generating unit 101, and a control unit 102. In this embodiment, the pin 100 is an open drain I/O. The generating unit 101 automatically generates different infrared signals each corresponding to a remote signal generated by a remote control (not shown) of the remote controlled device 2 when a button of the remote control is pressed. The control unit 102 alternatively sets the voltage at the pin 100 to be logic high and logic level to output the different infrared signals generated by the generating unit 101 to the infrared emitter 20. In this embodiment, the generating unit 101 is triggered to automatically generate the different infrared signals when a trigger signal is input via an input unit 30 of the infrared control device 1, for example, a particular button of the input unit 30 is pressed. If the remote controlled device 2 can execute a right function according to each infrared signal, it is determined that the remote controlled device 2 can be normally controlled by the remote control of the remote controlled device 2.

In the embodiment, two adjacent infrared signals are generated every a preset time interval.

With such configuration, during testing the remote controlled device 2, the infrared control device 1 automatically generates different remote signals to test the remote controlled device 2, rather than a user pressing buttons of the remote control of the remote controlled device 2 one by one, which improves test efficiency.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments.

What is claimed is:

1. An infrared control device configured to remotely control a remote controlled device, the infrared control device comprising:
an infrared emitter; and
a processor comprising:
a pin connected to the infrared emitter;
a generating unit to automatically generate different infrared signals each corresponding to a remote signal generated by a remote control of the remote controlled device; and
a control unit to alternatively set a voltage at the pin to be logic high and logic level to output the different infrared signals to the infrared emitter.

2. The infrared controlled device of claim 1, further comprising an input unit, wherein the generating unit is triggered to automatically generate the different infrared signals when a trigger signal is input via the input device.

3. The infrared device of claim 1, wherein the pin is an open drain I/O.

4. The infrared device of claim 1, wherein two adjacent remote signals are generated every a preset time interval.
